(19) United States
(12) Patent Application Publication
(10) Pub. No.: US 2005/0080971 A1
(43) Pub. Date: Apr. 14, 2005

(54) Controller-less board swap

(76) Inventor: Christopher Anthony Brand, New Westminster (CA)

Correspondence Address: Peter van Baarsen;c/o Spectrum Signal Processing Inc., 200-2700 Production Way, Burnaby, BC, V5A 4X1, CA

(21) Appl. No.: 10/671,620

(22) Filed: Sep. 29, 2003

(51) Int. Cl. G06F 13/00

(52) U.S. Cl. 710/302

(57) ABSTRACT

A method of effecting a live extraction/insertion of a board, without using a centralized controller, by empowering the remaining boards with communications capabilities independent of the communications normally controlled by the centralized controller.

### NOTICE REGARDING COPYRIGHTED MATERIAL

A portion of the disclosure of this patent document contains material which is subject to copyright protection. The copyright owner has no objection to the facsimile reproduction of the patent document or the patent disclosure as it appears in the Patent and Trademark Office file or records, but otherwise reserves all copyright rights whatsoever.

### FIELD OF THE INVENTION

This invention relates to live insertions and extractions of boards.

### BACKGROUND OF THE INVENTION

Some high performance, “high availability” systems require that they suffer only minimal downtime (due to failures, maintenance, upgrades or system reconfigurations), and that often requires, in particular, insertion and extraction of boards while the system is active. For example, a satellite earth station system may dedicate to each of its many communications channels, its own board. There are spare boards on standby. When the subject board fails, it is desirable to direct the processing of the associated channel to a spare board and facilitate the replacement of the failed board, all without having to power down the system. This invention is directed to facilitating that replacement and related functions.

### SUMMARY OF THE INVENTION

There is provided, in a system having an application and a plurality of boards, where the application is implemented by several software processes operating with the assistance of middleware between said boards and the application, and where said plurality of boards are adaptable to communicate pursuant to a standard that contemplates a controller dedicated therewith, a method for removing a subject board from the system while the application is running (a “hotswap”), comprising the steps of: a) connecting the boards with a communications channel in addition to that of the standard; b) preventing any new transactions on the subject board; c) notifying relevant other boards; d) waiting for appropriate responses from relevant other boards; and e) waiting for subject board to quiesce; where steps b) to e) are effected using said additional communications channel.

### BRIEF DESCRIPTION OF THE DRAWINGS

A better understanding of the present invention can be obtained when the following detailed description of the preferred embodiment is considered in conjunction with the following drawings, in which:

FIG. 1 is an example of a conventional CompactPCI® Hot Swap implementation (being FIG. 39 in Appendix A of CompactPCI® Hot Swap Specification PICMG 2.1 R.20 (Jan. 17, 2001); and

FIG. 2 is a circuit diagram that, according to the present invention, allows a board to satisfy both the CompactPCI® Hot Swap Specification and to detect the opening of its own handle.

### DETAILED DESCRIPTION OF THE PREFERRED EMBODIMENT

Herein, a “device” typically has “microprocessor and related functionality”, and a “board” is the physical implementation of a device (which typically includes a microprocessor but may implement “microprocessor functionality” with alternative means, like an FPGA or other Programmable Logic Device). The board has an interface with a human operator as follows—a handle (or similar electromechanical latch for the operator to manipulate to signal an intention to physically extract by generating an interrupt to the board's processor) and a blue LED (or similar indicator to indicate to the operator that it is safe to physically extract). The boards may communicate by a conventional bus means, such as CompactPCI but this invention does not require them to, since for some applications, the boards may simply be using the form factors of a conventional bus standard and not using the bus for communications.

The “live” insertion and/or extraction of a subject board (i.e. without powering down the system) is herein called generally “hotswap” (one word). When supported and implemented by a particular conventional bus standard (such as CompactPCI® Hot Swap Specification PICMG 2.1 R2.0 Jan. 17, 2001), the process is identified by the simplified name of the standard (i.e. “CompactPCI Hot Swap”).

The term, “quiescent”, and cognate terms, when applied to a board, refers to the state wherein all in-progress transactions have completed.

The system needs to react appropriately to an increase or decrease in available resources (e.g. by redistributing work among the available boards). To do so, it is important that notification of the change in configuration is distributed appropriately throughout the system. If there are direct communications between boards, it may be necessary for this direct communication to cease before the subject board is physically removed from the system.

In a CompactPCI system, extraction is a two-phase process. The first phase is the opening of the handle on the subject board, which generates a notification that its extraction is imminent. The system then has an opportunity to quiesce the subject board before lighting a blue LED on the subject board, to indicate that it is now safe for extraction. In a CompactPCI system, the notification takes the form of an interrupt to the System Host (which, as a central resource, provides configuration of the CompactPCI bus, and clocks and arbitration therefore, and plays a central role in “Dynamic Configuration”, a process whereby a Hot Swap board is allocated system resources following insertion of the board). In systems where there is no traffic over the CompactPCI bus, handling this interrupt may be the only reason for a System Host to be present and thus it would be advantageous to operate without the System Host. Accordingly, it is advantageous if standard components recognized by conventional bus standards (e.g. for CompactPCI Hot Swap) are still present, allowing operation both with and without a System Host.

In an embedded system with no centralized control, entities which care about insertion or extraction events may be distributed on different processors (i.e. boards) throughout the system. Such entities may care about hotswap events in one of two ways: they may be interested in knowing about a hotswap event within some defined time of its occurrence, or they may need to know about an imminent hotswap event in order to take appropriate action before it occurs. In the former case, mere notification of completion of the event is sufficient. However the latter case demands an acknowledgement on the part of the interested entity before the hotswap event occurs. The mechanism used for both cases should ideally provide complete decoupling of interested entities and sources of hotswap events and achieve an acceptable response time so that completion and notification of events is not unduly delayed.

This invention equips the boards (and processes therein and therewith) with additional means for communicating with each other, other than through the standard bus mechanism (e.g. independently of the CompactPCI bus). This additional communication means has two aspects, corresponding roughly to the lower and upper levels of the OSI reference model (e.g. cable and COBRA), explained next.

For the first aspect, to avoid inter-board communications proceeding exclusively through the bus for the boards, the boards are physically connected otherwise. This method of communication may be conventional (e.g. wires through which communications operates on Ethernet protocol, or wireless) or proprietary. Many current boards have built-in Ethernet ports and firmware such that only minimal steps are necessary to establish a non-bus communication channel (i.e. connecting all the boards by Ethernet cables) among them. Note that this provides the functional advantages of CompactPCI Hot Swap without the weaknesses thereof (i.e. there is no single points of failure as found in the case of a single System Host or a single CompactPCI backplane (because, in the exemplary preferred embodiment, the Ethernet communications among the boards eliminates such weaknesses).

The second aspect is advantageous for complex applications (although the degree of complexity of implementing the second aspect depends on the complexity of the application and performance requirements). The preferred embodiment uses CORBA (Common Object Request Broker Architecture) as an enabler for hotswap management among the boards. In particular, the CORBA Event Service or Notification Service provides a convenient method for communicating hotswap events through the system.

This second aspect is implemented by middleware residing between the hardware of the boards (including the subject board to be extracted) and the application. Middleware is implemented in the preferred embodiment, using three main components: (1) quicComm, software library that supports inter-processor communications in a heterogeneous processing environment, from Spectrum Signal Processing Inc., (2) VxWorks®, a real-time operating system for embedded architectures, from Wind River Systems, Inc., and (3) as mentioned above, CORBA, a conventional technology that allows objects within distributed object-oriented programs to invoke methods remotely. Related to the above main components and as part of middleware, is hardware-proximate interface software (such as board support libraries to map between quicComm and hardware, and map between VxWorks and hardware), herein collectively called “Board Support”.

quicComm must respond to two types of hotswap events—insertions and extractions. In general, there are more rigorous timing requirements for extractions than for insertions. Conventionally, the notification of these events normally occurs in a “bottom-up” fashion, with a CompactPCI device driver detecting an interrupt, polling the CompactPCI bus to detect the subject device and proceeding from there. In an SDR (Software Defined Radio) system, it is desirable to allow for “top-down” notification, where a board may use a mechanism such as CORBA to inform other boards that it is being extracted, thus avoiding the requirement for a System Host to be present. Also, in an SDR system, there may be boards sending data over the switched fabric to the subject board to be extracted. Ideally, an application should be given a chance to stop this data flow before the blue LED is lighted.

A hotswap could affect quicComm at all levels—from the highest level software objects (e.g. first call to quicComm_Open( ) to open a system), down to device drivers. In essence, every software object may need to be aware that its corresponding hardware may be physically present or absent. That said, it may be possible in many cases to leave this knowledge at the lowest levels of the software hierarchy. If an attempt is made to send data to hardware that is not present, the lowest level will clearly be unable to fulfill this request and will return an appropriate error. As such attempts should be rare (because the application will be aware of the presence or absence of each board), the overhead involved in detecting such a problem later is generally acceptable.

Because of the need to allow the application sufficient time to communicate hotswap events to other boards and to wait for them to take appropriate action before lighting the blue LED of the subject board, most of the extraction process has to be performed within the context of the task that provides notification to quicComm of the event (as part of middleware's quicCommCompactPCIHot SwapLib). In other words, there needs to be an acknowledgement so that the subject board's middleware is satisfied.

To avoid “race conditions” between insertion and extraction events (i.e. when they occur in quick succession), it makes sense to do the same for the vast majority of extraction processing, too.

To ease application design, on system startup, all quicComm objects will assume that the hardware they correspond to is not present until they find out otherwise. As boards are detected, simulated insertion events will be generated to the application. This allows the application to use the same code to deal with a board that is present when the system is first powered up and when the same board is later inserted.

There are four, fundamental, distinct events for the system to handle: Local Extraction, Remote Extraction, Local Insertions or Aborted Extraction, and Remote Insertions or Aborted Extractions. For each fundamental event, there is a process or sequence of steps to be performed as described below, where the Local Extractions are seen from the viewpoint of the subject board and the Remote Extractions are seen from the viewpoint of the other boards, in particular, and of the system, generally.

The essence of the extraction process for a subject board, is summarized in the following conceptual sub-processes:
1. Prevent any new transactions on the subject board
2. Notify relevant other boards
3. Wait for “appropriate responses” from relevant other boards
4. Wait for subject board to quiesce.

These sub-processes are not necessarily sequential. For example, sub-process 4 can be done before or concurrently with sub-processes 2 and 3. Also, an “appropriate response” may be an actual message from a relevant other board indicating to the subject board that it is appropriate, from that other board's point of view, for the subject board to be extracted; or an “appropriate response” may simply be waiting for a timeout whose duration is preset appropriately for the application, in general, or the boards, in particular.

The extraction process (and other relevant processes), implemented in more step-like fashion, is explained below. The parts of the system that need to know of a fundamental event, other than the subject board, are called herein for economy of expression, “Remainder of the System”. The examplary references are to specific quicComm processes.

Local Extractions

1. Event reported by Board Support (e.g. quicCommCompactPCIHot SwapLib)
2. Prevent new transactions on all appropriate boards
3. Inform the application through middleware (e.g. quicComm's HS_EventWait ( ))
4. Wait for the application to respond through middleware (e.g. quicComm HS_ExtractionHandledNotify( ), or timeout)
5. Wait for appropriate boards to report that they are quiescent
6. Inform Remainder of the System that the subject board is no longer present
7. Return control to Board Support (e.g. quicComm CompactPCIHot SwapLib) to light the blue LED.
   Remote Extractions
1. Application calls middleware (e.g. quicComm HS_Quiesce( )) to report the event
2. Prevent new transactions on all appropriate boards
3. Wait for appropriate boards to report that they are quiescent
4. Inform Remainder of the System that the subject board is no longer present
5. Return control to the application.
   Local Insertions or Aborted Extractions
1. Event reported by Board Support (e.g. quicCommCompactPCIHot SwapLib)
2. May need to extinguish the blue LED for an aborted extraction
3. Find appropriate software object(s)
4. Unquiesce appropriate boards, allowing them to be used
5. Inform Remainder of the System that the subject board is now present
6. Inform the application through middleware (e.g. quicComm cHS_EventWait ( )).
   Remote Insertions or Aborted Extractions
1. Application calls middleware (e.g. quicComm HS_InsertNotify( )) to report the event
2. Unquiesce appropriate boards, allowing them to be used
3. Inform Remainder of the System that the subject board is now present
4. Return control to the application

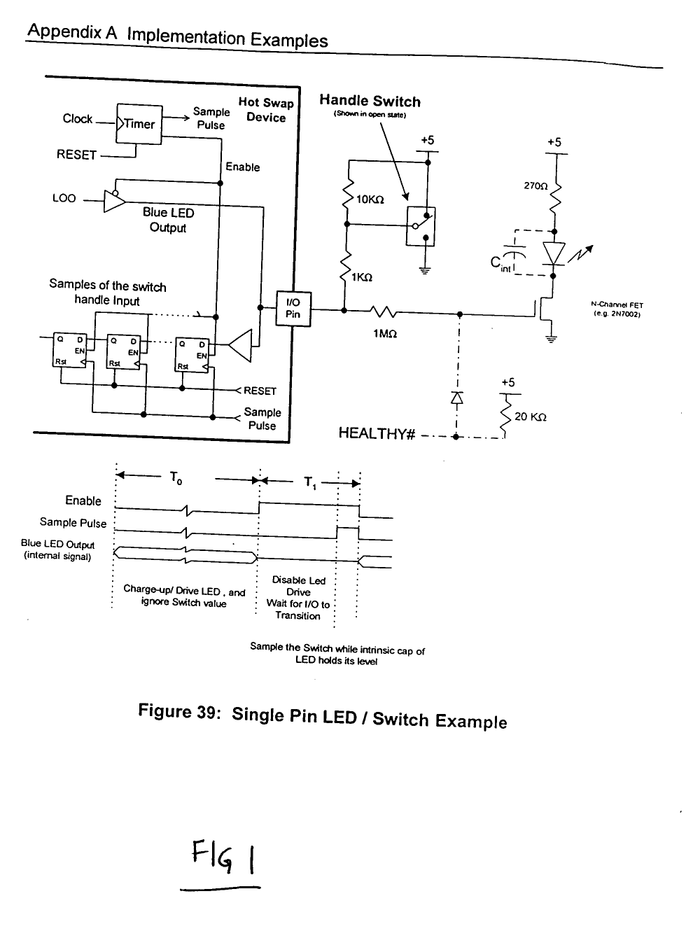

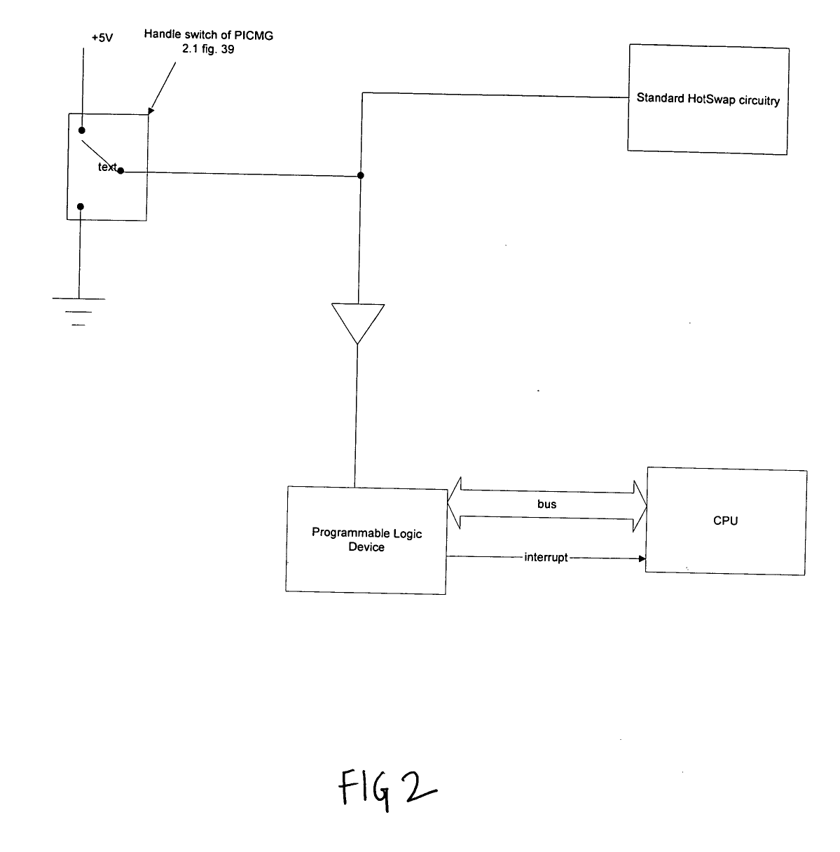

FIG. 1 is an example of a conventional CompactPCI Hot Swap implementation, being page 140, FIG. 39 in Appendix A of CompactPCI Hot Swap Specification PICMG 2.1 R.20 (Jan. 17, 2001). FIG. 2 is a circuit diagram that, according to the present invention, allows a board to satisfy both the CompactPCI Hot Swap Specification (with examplary reference to FIG. 1) and to detect the opening of its own handle. Attached hereto, and incorporated as part of this application, is draft CompactPCI Hot Swap Specification PICMG 2.1 D0.91 (Feb. 5, 1998), which is equivalent to CompactPCI Hot Swap Specification PICMG 2.1 R.20 (Jan. 17, 2001) referred to herein for purposes of this invention (i.e. the differences between the draft and the standard are not relevant to this invention).

Ancillary to fundamental events are ones like system startup/shutdown, errors detected during board insertion. Also, Remote Extraction can be advantageously employed by an application that predicts the failures of boards and schedules their replacement before actual failures. The preceding are merely two examples where those skilled in the art can implement and use the present invention advantageously.

Also, the methods of the present invention can be employed advantageously where control of the fundamental events and processes resides remotely from the physical chassis where the boards are located and communications therebetween is accomplished by the additional means for communications (mentioned above, e.g. Ethernet cabling). Thus control of hotswap events (and processes and sub-processes) according to the present invention, can be centrally effected over a plurality of chassis of boards, thus negating or reducing the need for each chassis of boards to have their own “hotswap” control functionality.

Although the preferred embodiment has been described relative to the CompactPCI standard, this invention is not restricted thereto. The invention is equally applicable, with obvious changes as applicable, to other standards for connecting (peripheral) boards via a bus. Examples include the PCI standard (PCI Local Bus Specification Rev. 2.2, Dec. 18, 1998, and subsequent revisions), as well as the VME standard (Versa Module European—IEEE 1014-1987 standard) (whose “System Controller” is equivalent, for purposes of this invention, to CompactPCI's Hot Swap's “System Host”).

Although in the preferred embodiment, middleware was implemented by quicComm, VxWorks and CORBA, it is understood by those skilled in the art that other implementations are possible and are within the design choices of those skilled in the art.

Although in the preferred embodiment, an example of a “top-down” notification referred to an SDR system, any application whose software processes are complex, could advantageously be the subject of the present invention.

As mentioned above, the “middleware” depends on the complexity of the application and on performance requirements. Although the preferred embodiment uses a plurality of middleware software for a relatively complex application, it is conceivable that for a particular, simple application, the amount of middleware is so “thin” that it can be considered part of the application. Accordingly, the use of the term “middleware” herein should not be interpreted to preclude its inclusion in the term “application” in some situations. In some situations, there is no “discrete middleware” because the particular application, for its purposes, is sufficient to interact with the hardware without discrete middleware therebetween.

The CompactPCI Hot Swap standard provides for a “Hot Swap Controller”, being a central device capable of exercising hardware connection control in effecting CompactPCI Hot Swaps. Whether this central device is implemented as (or considered) part of System Host or not for other purposes, this invention does not make a distinction and considers the Hot Swap Controller to included in the references to System Host as a matter of terminological convenience herein.

Although the preferred embodiment suggests Ethernet communications links among the boards, this invention does not restrict the type or topology of the links, although obviously, single-point-of-failure links are not preferred.

Details of quicComm are publicly available at, for example, quicComm API Programming Guide #DOC-500-00603 Rev. 1.00 February 2002 from Spectrum Signal Processing Inc.

Details of VxWorks are publicly available at VxWorks Programmer's Guide 5.4 Edition 1 25 Mar. 99 Part # DOC-12629-ZD-01 from Wind River Systems, Inc.

Details of CORBA are publicly available in many publications including CORBA Notification Service Specification Version 1.0.1 from the OMG at http://www.omg.org/docs/formal/02-08-04.pdf and CORBA Event Service Specification Version 1.1 March 2001 from the OMG at http://www.omg.org/docs/formal/01-03-01.pdf.

Amplification of the CORBA implementation aspects of this invention is found below at the end of this specification, as pages 10a to 10g with drawings on pages 10h to 10j, which are incorporated herein as part of this specification.

Although the method and apparatus of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

1. In a system having an application and a plurality of boards, where the application is implemented by several software processes operating with the assistance of middleware between said boards and the application, and where said plurality of boards are adaptable to communicate pursuant to a standard that contemplates a controller dedicated therewith, a method for removing a subject board from the system while the application is running (a “hotswap”), comprising the steps of:
(a) connecting the boards with a communications channel in addition to that of the standard;
(b) alerting subject board of the intention to remove it;
(c) subject board reporting its alerted state to middleware;
(d) preventing new transactions on all appropriate boards in accordance with the application;
(e) informing the application through middleware;
(f) waiting for the application to respond to middleware;
(g) waiting for appropriate boards to report that they are quiescent;
(h) informing all parts of the system other than the subject board, that need to know, that the subject board is no longer present;
(i) returning control to the subject board to signal that extraction of the subject board can be safely performed.

2. The method of claim 1 wherein each said board is represented by a corresponding middleware object, and communications services among said board objects are implemented using CORBA, and steps c) to h) above, are implemented using CORBA.

3. The method of claim 2, wherein said steps c), g) and h) are effected by using said additional communications channel.

4. The method of claim 3, wherein the standard is one of {CompactPCI, PCI, VME}.

5. The method of claim 4, wherein said additional communications channel, operates on Ethernet protocol.

6. The method of claim 5, wherein said controller includes functionality for hardware connection control in effecting a hotswap according to the standard.

7. The method of claim 6, wherein said controller is not present.

8. The method of claim 2, wherein the control of such method is effected physically remotely from the chassis of the boards, using said additional communications channel.

9. The method of claim 1, where the boards which are adaptable to communicate pursuant to a standard, are configured not to so communicate.

10. In a system having an application and a plurality of boards, where the application is implemented by several software processes, and where said plurality of boards are adaptable to communicate pursuant to a standard that contemplates a controller dedicated therewith, a method for removing a subject board from the system while the application is running (a “hotswap”), comprising the steps of:
(a) connecting the boards with a communications channel in addition to that of the standard;
(b) alerting subject board of the intention to remove it;
(c) subject board reporting its alerted state to middleware;
(d) preventing new transactions on all appropriate boards in accordance with the application;
(e) informing the application through middleware;
(f) waiting for the application to respond to middleware;
(g) waiting for appropriate boards to report that they are quiescent;
(h) informing all parts of the system other than the subject board, that need to know, that the subject board is no longer present;
(i) returning control to the subject board to signal that extraction of the subject board can be safely performed.

11. The method of claim 10, wherein said steps c), g) and h) are effected by using said additional communications channel.

12. The method of claim 11, wherein said additional communications channel, operates on Ethernet protocol.

13. The method of claim 12, wherein said controller includes functionality for hardware connection control in effecting a hotswap according to the standard.

14. The method of claim 13, wherein said controller is not present.

15. The method of claim 14, wherein the control of such method is effected physically remotely from the chassis of the boards, using said additional communications channel.

16. The method of claim 15, where the boards which are adaptable to communicate pursuant to a standard, are configured not to so communicate.

17. In a system having an application and a plurality of boards, where the application is implemented by several software processes operating with the assistance of middleware between said boards and the application, and where said plurality of boards are adaptable to communicate pursuant to a standard that contemplates a controller dedicated therewith, a method for removing a subject board from the system while the application is running (a “hotswap”), comprising the steps of:
a) connecting the boards with a communications channel in addition to that of the standard;
b) preventing any new transactions on the subject board;
c) notifying relevant other boards;
d) waiting for appropriate responses from relevant other boards; and
e) waiting for subject board to quiesce;
where steps b) to e) are effected using said additional communications channel.

18. The method of claim 17, wherein each said board is represented by a corresponding middleware object, and communications services among said board objects are implemented using CORBA, and steps c) to h) above, are implemented using CORBA.

19. The method of claim 20, wherein the standard is one of {CompactPCI, PCI, VME}.
